(19) United States
(12) Patent Application Publication
(10) Pub. No.: US 2026/0008323 A1
(43) Pub. Date: Jan. 8, 2026

(54) MANIFOLD FLUID MODULE INTEGRATED WITH GAS-LIQUID SEPARATOR

(71) Applicant: HANON SYSTEMS, Daejeon (KR)

(72) Inventors: Seong Hun KIM, Daejeon (KR); Kyung Tae NOH, Daejeon (KR); Yun Jin KIM, Daejeon (KR); Hae Jun LEE, Daejeon (KR); Sung Je LEE, Daejeon (KR)

(21) Appl. No.: 18/881,122

(22) PCT Filed: Jun. 23, 2023
(86) PCT No.: PCT/KR2023/008726

§ 371 Date: Jan. 3, 2025

(30) Foreign Application Priority Data
Jul. 15, 2022 (KR) 10-2022-0087568

(51) Int. Cl. B60H 1/32; B60H 1/00; F25B 43/00

(52) U.S. Cl. CPC B60H 1/3229; B60H 1/00485; F25B 43/00; B60H 2001/3285; F25B 2400/23

(57) ABSTRACT

An embodiment relates to a manifold fluid module integrated with a gas-liquid separator. The manifold fluid module integrated with the gas-liquid separator according to the embodiment may include a manifold plate including a fluid passage formed internally, a heat exchanger coupled to the manifold plate for heat exchange between a first fluid and a second fluid, a first expansion valve coupled to the manifold plate and configured to block the flow of the first fluid or expand the first fluid based on air conditioning mode, and a gas-liquid separator at least partially integrally formed with the manifold plate to create an inflow space for the first fluid expanded by the first expansion valve and to separate the first fluid into gas and liquid phases.

### TECHNICAL FIELD

The present invention relates to a manifold fluid module, and more particularly, to a manifold fluid module modularizing components such as a gas-liquid separator, a heat exchanger, and valves into a single unit.

### BACKGROUND ART

Amidst the growing emphasis on environmentally friendly industrial development and

the pursuit of energy sources to replace fossil fuels, electric vehicles and hybrid vehicles have emerged as the most prominent areas of interest in the automotive industry. Both electric vehicles and hybrid vehicles are equipped with batteries to provide driving power, and these batteries are also utilized for heating and cooling purposes in addition to driving operations.

In vehicles that rely on batteries for propulsion, using the battery as a heat source for heating and cooling inevitably leads to a reduction in driving range; to address this issue, the integration of heat pump systems, which have been widely employed in residential heating and cooling systems, into automobiles has been proposed.

Essentially, a heat pump operates by absorbing low-temperature heat and transferring it to a higher temperature. For example, a heat pump cycle involves a liquid fluid evaporating in an evaporator, absorbing heat from its surroundings and becoming a gas, then releasing heat to its surroundings through a condenser and becoming liquid again. Applying this principle to electric or hybrid vehicles offers the advantage of providing a supplementary heat source that is absent in conventional air conditioning systems.

Current electric vehicle heat pump systems employ a partial modularization approach where key components (valves, gas-liquid separators, chillers, condensers, internal heat exchangers, sensors, etc.) are connected by piping, requiring separate fittings and connectors for these connections and resulting in necessary spacing between components. These factors lead to drawbacks in terms of packaging, cost, and workability. To address these issues, technologies for modularizing manifolds are being developed.

### DISCLOSURE

### Technical Problem

An embodiment of the present invention aims to provide a manifold fluid module integrated with a gas-liquid separator that is capable of reducing costs and improving workability by modularizing not only heat exchanger and valves but also a gas-liquid separator into a single unit.

### Technical Solution

A manifold fluid module integrated with a gas-liquid separator according to an embodiment of the present invention may include a manifold plate including a fluid passage formed internally, a first expansion valve coupled to the manifold plate and configured to block the flow of a first fluid or expand the first fluid based on air conditioning mode, and a gas-liquid separator at least partially integrally formed with the manifold plate to create an inflow space for the first fluid expanded by the first expansion valve and to separate the first fluid into gas and liquid phases.

The gas-liquid separator may be positioned on the upper part of the manifold plate.

The gas-liquid separator may be positioned on the outside of the manifold plate.

The gas-liquid separator may include a housing having an internal space through which the first fluid flows, a discharge tube positioned in the upper part of the housing to discharge the gas phase of the first fluid and prevent the inflow of the liquid phase of the first fluid, and a top cap coupled to the top of the housing to be positioned between the housing and the discharge tube.

The housing may be formed integrally with the manifold plate, and the top cap may be separately fabricated to be coupled to the top of the housing.

The housing may include a fluid inlet path formed on one side of the upper part of the housing for the first fluid expanded by the first expansion valve, and the fluid inlet path may be configured to open tangentially for the first fluid to form a spiral vortex.

The first expansion valve may expand the first fluid to move the expanded fluid to the gas-liquid separator in vapor injection heat pump mode and may remain closed in normal heat pump mode to allow the first fluid to flow toward the second expansion valve.

The manifold fluid module integrated with a gas-liquid separator may further include a second expansion valve coupled to the manifold plate for expanding the liquid phase of the first fluid separated in the gas-liquid separator, and a third expansion valve coupled to the manifold plate for expanding the first fluid that has exchanged heat with an external heat exchanger.

The manifold fluid module integrated with a gas-liquid separator may further include a heat exchanger coupled to the manifold plate for heat exchange between the first fluid and a second fluid, wherein the heat exchanger may include a first heat exchanger for heat exchange between the first fluid expanded by the second expansion valve and the second fluid, and a second heat exchanger for heat exchange between the first fluid expanded by the third expansion valve and the second fluid.

The first heat exchanger may be arranged on one side of the manifold plate, and the second heat exchanger may be arranged laterally to the first heat exchanger.

The first expansion valve and the second expansion valve may be positioned above the first heat exchanger, and the third expansion valve may be positioned above the second heat exchanger, allowing the first fluid flowing into the first and second heat exchangers to move from top to bottom.

The manifold fluid module integrated with a gas-liquid separator may further include a first direction switching valve and a second direction switching valve for controlling the direction of the first fluid discharged from the first heat exchanger, wherein the first direction switching valve may be positioned below the second heat exchanger, and the second direction switching valve may be positioned between the first heat exchanger and the second heat exchanger.

The gas-liquid separator, the first expansion valve, the second expansion valve, and the third expansion valve may be arranged on the upper part of the manifold plate, the first heat exchanger may be arranged on one side of the lower part of the manifold plate, and the second heat exchanger, the first direction switching valve, and the second direction switching valve may be arranged on the other side of the lower part of the manifold plate.

### ADVANTAGEOUS EFFECTS

The manifold fluid module integrated with a gas-liquid separator according to an embodiment of the present invention is advantageous in terms of reducing costs and improving workability by modularizing not only heat exchanger and valves but also a gas-liquid separator into a single unit.

### DESCRIPTION OF DRAWINGS

FIG. 1 is a front perspective view of a manifold fluid module integrated with a gas-liquid separator according to an embodiment of the present invention;

FIG. 2 is a front cross-sectional view of the portion where a gas-liquid separator is combined in a manifold fluid module integrated with the gas-liquid separator according to an embodiment of the present invention;

FIG. 3 is a plan view illustrating the portion where a gas-liquid separator is combined in the manifold fluid module according to an embodiment of the present invention;

FIG. 4 is a view illustrating the flow of the first fluid around a gas-liquid separator in vapor injection heat pump mode; and

FIG. 5 is a view illustrating the flow of the first fluid around the gas-liquid separator in normal heat pump mode.

### MODE FOR INVENTION

While the present invention admits various modifications, the following detailed descriptions and drawings focus on preferred embodiments for clarity. However, such embodiments are not intended to limit the invention and it should be understood that the embodiments encompass all modifications, equivalents, and alternatives within the spirit and scope of the invention. Detailed descriptions of well-known technologies may be omitted to avoid obscuring the subject matter of the present invention.

Terms such as “first,” “second,” etc. may be used to describe various components, but the components should not be limited by these terms. The terms are used only for distinguishing one component from another component.

The terminology used in this application is employed merely to describe specific embodiments and is not intended to limit the scope of the present invention. The singular forms are intended to include the plural forms as well unless the context clearly indicates otherwise. In this application, terms such as “comprising” or “having” indicate the presence of the features, numbers, steps, operations, components, or parts listed in the specification, without excluding the presence or possibility of one or more other features, numbers, steps, operations, components, or parts or their combinations.

Throughout the specification, the term “connected” not only means that two or more components are directly connected but also includes indirect connections via intermediary components, electrical connections, and instances where components are referred to by different names based on their position or function but are considered as a whole.

Hereinafter, a description is made of the manifold fluid module according to an embodiment of the present invention with reference to accompanying drawing, where identical or corresponding components are assigned the same reference numerals and repetitive descriptions are omitted.

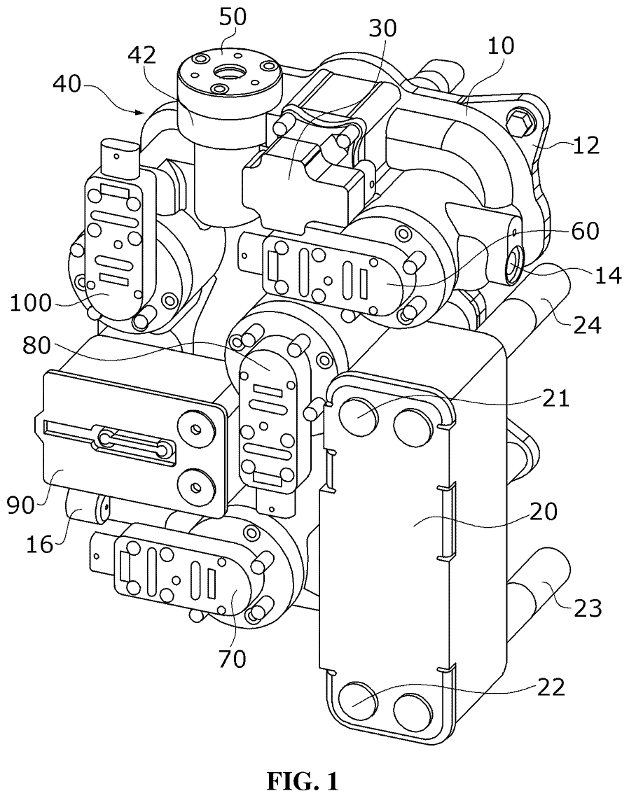

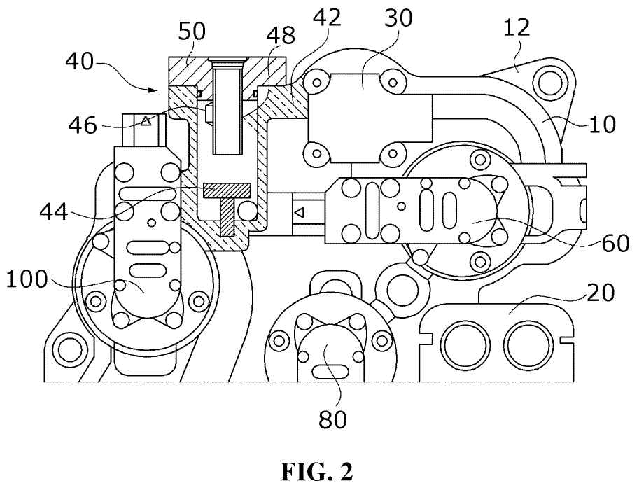

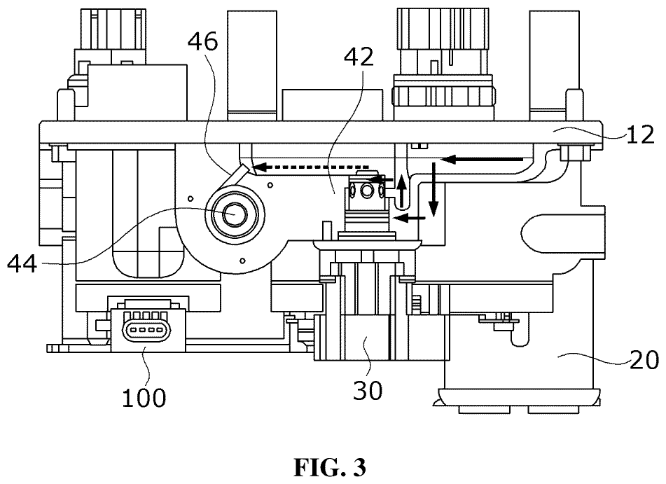

FIG. 1 is a front perspective view of a manifold fluid module integrated with a gas-liquid separator according to an embodiment of the present invention, FIG. 2 is a front cross-sectional view of the portion where a gas-liquid separator is combined in a manifold fluid module integrated with the gas-liquid separator according to an embodiment of the present invention, and FIG. 3 is a plan view illustrating the portion where a gas-liquid separator is combined in the manifold fluid module according to an embodiment of the present invention.

As shown in the drawings, the manifold fluid module integrated with a gas-liquid separator according to an embodiment of the present invention may include a manifold plate 10 forming a fluid passage internally, heat exchangers 20 and 90 coupled to the manifold plate 10 for heat exchange between the first fluid and the second fluid, a first expansion valve 30 coupled to the manifold plate 10 for blocking the flow of the first fluid or expanding the first fluid in air conditioning mode, and a gas-liquid separator 40 at least partially integrally formed with the manifold plate 10 to create an inflow space for the expanded first fluid from the first expansion valve 30 and to separate the first fluid into gas and liquid phases.

The manifold plate 10 may have a bottom plate 12 coupled to one side to cover the fluid passage, using methods such as brazing, structural adhesives, and gaskets. The material for the manifold plate 10 may vary depending on the application and function, such as aluminum, thermoplastic materials, or stainless steel, chosen according to specific needs.

The manifold plate 10 is generally formed with fluid passages recessed into its interior and has a plate shape with a predetermined thickness. The manifold plate 10 with such a shape is modularized with the first heat exchanger 20 and the second heat exchanger 90, which are heat exchange devices of the heat pump system, along with expansion valves 30, 60, and 100 and switching valves 70 and 80, thereby reducing manufacturing labor and assembly line labor in vehicle production. In addition, the manifold plate 10 may reduce costs and improve workability by performing the functions of piping, fittings, and housing at the same time.

A fluid inlet port 14 is formed on one side of the upper part of the manifold plate 10 for the inflow of the first fluid. Additionally, an accumulator port 16 is formed on one side of the lower part of the manifold plate 10 for the discharge of the first fluid to an accumulator (not shown).

On one side of the manifold plate 10, specifically the front side, the first heat exchanger 20 and the second heat exchanger 90 are combined as heat exchange devices. The first heat exchanger 20 and the second heat exchanger 90 allow the first fluid and the second fluid to pass through, exchanging heat therebetween.

In this embodiment, the first heat exchanger 20 may be a water-cooled condenser, and the second heat exchanger 90 may be a chiller. A water-cooled condenser serves to exchange heat between the high-temperature, high-pressure gaseous fluid (refrigerant) discharged from a compressor or internal condenser with an external heat source, thereby condensing the fluid into a high-pressure liquid. A chiller is a device for heat exchange between a low-temperature, low-pressure fluid supplied thereto and a fluid (coolant) circulating in a coolant circulation line (not shown), and the chilled coolant resulting from the heat exchange in the chiller circulates through the coolant circulation line and then used to exchange heat with a battery.

While various fluids such as refrigerants and coolants can be employed as the first and second fluids, this embodiment employs refrigerant as the first fluid and coolant as the second fluid.

The first heat exchanger 20 is equipped with first fluid ports for the inlet and outlet of the first fluid. The first fluid ports include a first inlet port 21 and a first outlet port 22, which are respectively provided at the top and bottom of the first heat exchanger 20. The first inlet port 21 serves as the entry point of the first fluid passed through the second expansion valve 60, while the first outlet port 22 serves as the exit point of the first fluid after heat exchange in the first heat exchanger 20. The first inlet port 21 and the first outlet port 22 may be formed at the top and bottom of the first heat exchanger 20 in the form of a hole.

In this case, considering thermal interference, the first inlet port 21 may be formed on one side close to the second expansion valve 60, and the first outlet port 22 may be formed on the opposite side, farther away from the second expansion valve 60. In more detail, the first inlet port 21 may be positioned closer to the second expansion valve 60 relative to the first outlet port 22. That is, the distance from the second expansion valve 60 to the first inlet port 21 may be shorter than the distance from the second expansion valve 60 to the first outlet port 22.

The first heat exchanger 20 is also equipped with second fluid ports for the inlet and outlet of the second fluid. The second fluid ports include a second inlet port 23 and a second outlet port 24, which are respectively provided at the bottom and top of the first heat exchanger 20. The second inlet port 23 serves as the entry point of the second fluid, while the second outlet port 24 serves as the exit point of the second fluid after heat exchange with the first fluid. The second fluid flows in the opposite direction (bottom to top) compared to the first fluid, while undergoing heat exchange with the first fluid.

The separation between the first fluid ports and the second fluid ports, as described above, is capable of enhancing the assembly efficiency of the first fluid piping and the second fluid piping.

The first expansion valve 30 serves to block the flow of the first fluid into the gas-liquid separator 40 or to expand the first fluid, depending on the air conditioning mode. The first expansion valve 30 may be positioned on the upper part of the manifold plate 10, expanding the first fluid to move the expanded fluid to the gas-liquid separator 40 in vapor injection heat pump mode, while in normal heat pump mode and cooling mode, the valve remains closed to allow the first fluid to flow toward the second expansion valve 60.

The gas-liquid separator 40 may receive the first fluid from the first expansion valve 30 and separate the fluid into gas and liquid phases. The gas-liquid separator 40 may direct the separated gas phase of the first fluid to a compressor (not shown) and the liquid phase to the second expansion valve 60.

In this embodiment, the gas-liquid separator 40 may be integrally formed at least partially with the manifold plate 10. The gas-liquid separator 40 is typically arranged as a separate component independent of the manifold fluid module, but in this embodiment, it is modularized together with the manifold fluid module, thereby reducing costs and improving workability.

To achieve this, a housing 42 that forms the exterior of the gas-liquid separator 40 and has an internal space through which the first fluid flows is integrally formed with the manifold plate 10. That is, the housing 42 may be manufactured to create the internal space during the production of the manifold plate 10, and a top cap 50 may be separately fabricated and attached to the top. Of course, the top cap 50 is not necessarily required to be separate and may be manufactured integrally with the gas-liquid separator 40.

The gas-liquid separator 40 may include a housing 42, a discharge tube 48 placed in the upper part of the housing 42 to discharge the gas phase of the first fluid and prevent the inflow of the liquid phase of the first fluid, and a top cap 50 that is coupled to the top of the housing 42 to be positioned between the housing 42 and the discharge tube 48.

The housing 42 is generally cylindrical, with an inner wall having a sloped surface. This sloped surface, gradually narrowing towards the bottom, helps to regulate the flow rate.

A deflector 44 may be coupled to the lower part of the housing 42 to prevent the splashing of the first fluid. The deflector 44 may prevent the first fluid from splashing and flowing into the discharge tube 48. The deflector 44 may be made in a disk shape and may have a diameter larger than that of the discharge tube 48. The deflector 44 may be secured to the lower part of the housing 42 by a rod structure.

A fluid inlet passage 46 is formed on one side of the upper part of the housing 42. The fluid inlet passage 46 is formed to open tangentially, allowing the first fluid that flows into the interior of the housing 42 to form a swirling vortex in a spiral motion.

The gas-liquid separator 40 described above may be placed on the upper part of the manifold plate 10. This is because positioning the gas-liquid separator 40 at the top when it is integrally manufactured with the manifold plate 10 allows the gas phase of the first fluid to be naturally discharged to the outside through the top. Additionally, placing the separator on top of the manifold plate 10 is the most efficient configuration for the flow of the first fluid (from top to bottom) considering the arrangement of other components already installed on the manifold plate 10.

The gas-liquid separator 40 may be positioned outside of the manifold plate 10. This allows the gas phase of the first fluid discharged from the gas-liquid separator 40 to be smoothly released outside the manifold plate 10 and also facilitates the connection of piping for the discharge of the first fluid to the top cap 50.

The second expansion valve 60 regulates the expansion of refrigerant entering the first heat exchanger 20. The first expansion valve 60 may be positioned above the first heat exchanger 20 and is responsible for controlling the expansion of the liquid phase of the first fluid that passes through the gas-liquid separator 40 or enters through the fluid inlet port 14. The first fluid entering through the second expansion valve 60 may pass through the first heat exchanger 20, undergoing heat exchange, or proceed to move to an external heat exchanger.

The first fluid discharged through the first outlet port 22 of the first heat exchanger 20 flows into the first direction switching valve 70. The first direction switching valve 70 controls the direction of the first fluid discharged from the first heat exchanger 20. In air conditioning mode, the first direction switching valve 70 allows the first fluid to be discharged to the external heat exchanger (air-cooled condenser), while in heat pump mode, the first directional control valve 70 redirects the first fluid to the accumulator port 16, allowing first fluid to be discharged to the accumulator.

The first fluid entering through the first expansion valve 30 may move to the evaporator (not shown) after passing through the second direction switching valve 80 in dehumidification mode.

The second heat exchanger 90 is supplied with a low-temperature, low-pressure first fluid for heat exchange with the coolant circulating in the coolant circulation line (not shown). The chilled coolant, which has undergone heat exchange in the second heat exchanger 90, may circulate through the coolant circulation line for heat exchange with the battery. The first fluid, after undergoing heat exchange with the external heat exchanger, flows into the third expansion valve 100 and, after being expanded in the third expansion valve 100, flows into the second heat exchanger 90. The first fluid, after undergoing heat exchange in the second heat exchanger 90, is discharged through the bottom and flows into the accumulator through the accumulator port 16.

In this embodiment, the gas-liquid separator 40, the first expansion valve 30, and the second expansion valve 60 may be arranged on the upper part of the manifold plate 10, the first heat exchanger 20 may be arranged on one side of the lower part of the manifold plate 10, and the second heat exchanger 90, the first direction switching valve 70, and the second direction switching valve 80 may be arranged on the other side of the lower part of the manifold plate 10. Here, the first direction switching valve 70 may be positioned below the second heat exchanger 90, while the second direction switching valve 80 may be placed between the first heat exchanger 20 and the second heat exchanger 90. The third expansion valve 100 may be positioned between the first heat exchanger 20 and the second heat exchanger 90.

That is, arranging the aforementioned components on the manifold plate 10 allows for optimal placement of the components in minimal space, thereby maximizing spatial efficiency, and the overall top-to-bottom formation of the fluid flow optimizes the fluid flow as well.

In particular, the first heat exchanger 20 is arranged vertically on one lower side of the manifold plate 10, and the second heat exchanger 90 is arranged horizontally on the other lower side of the manifold plate 10, thereby optimizing the fluid module package. That is, the second heat exchanger 90 is arranged laterally to the first heat exchanger 20, thereby enhancing space efficiency. Additionally, the first expansion valve 30 and the second expansion valve 60 are positioned above the first heat exchanger 20, and the third expansion valve 100 is positioned above the second heat exchanger 90, allowing the flow of the first fluid to naturally form from top to bottom.

Considering the overall arrangement of the manifold fluid module, the gas-liquid separator 40, the first expansion valve 30, the second expansion valve 60, and the third expansion valve 100 may be positioned on the upper part of the manifold plate 10, the first heat exchanger 20 may be located on one side of the lower part of the manifold plate 10, and the second heat exchanger 90, the first direction switching valve 70, and the second direction switching valve 80 may be arranged on the opposite side of the lower part of the manifold plate 10.

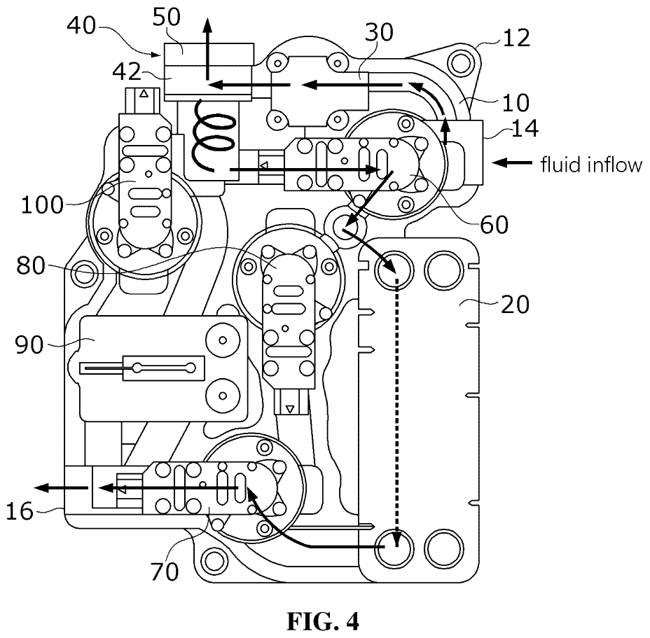

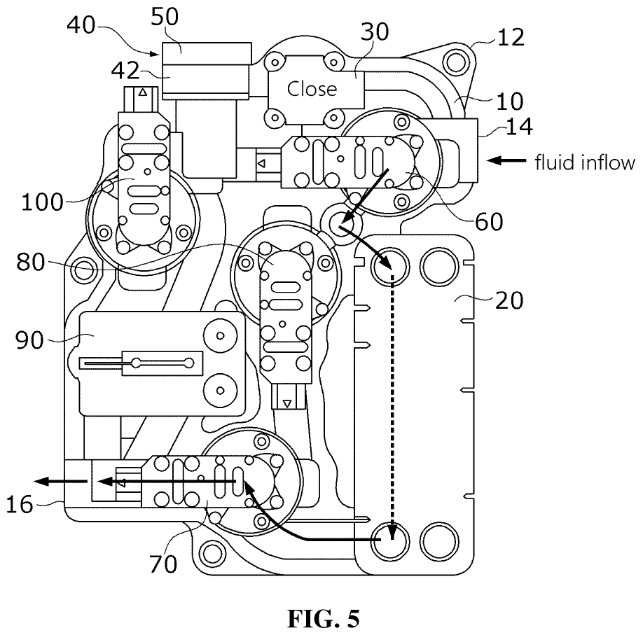

FIG. 4 is a view illustrating the flow of the first fluid around a gas-liquid separator in vapor injection heat pump mode, and FIG. 5 is a view illustrating the flow of the first fluid around the gas-liquid separator in normal heat pump mode.

With reference to FIG. 4, in the vapor injection heat pump mode, the first fluid entering through the fluid inlet port 14 is first expanded in the first expansion valve 30 before flowing into the gas-liquid separator 40. The first expansion valve 30 expands the incoming first fluid to an intermediate pressure, thereby reducing the load on the compressor and improving the heat exchange efficiency in the evaporator.

The first fluid flowing into the gas-liquid separator 40 spirals down along the sidewall of the housing 42, and the liquid phase of the first fluid separated in the gas-liquid separator 40 enters the second expansion valve 60 for secondary expansion. Meanwhile, the gas phase of the first fluid separated in the gas-liquid separator 40 is discharged upward along the discharge tube 48 and may flow into the compressor.

The first fluid, after undergoing secondary expansion in the second expansion valve 60, enters the first heat exchanger 20 for heat exchange with the second fluid. The first fluid that passes through the first heat exchanger 20 may flow into the first direction switching valve 70. The first fluid entering the first direction switching valve 70 is discharged to the accumulator through the accumulator port 16. The first fluid entering from the external heat exchanger to the third expansion valve 100 is discharged to the accumulator through the accumulator port 16.

With reference to FIG. 4, in the normal heat pump mode, the first expansion valve 30 is closed to prevent the first fluid from flowing into the gas-liquid separator 40. This also applies similarly to the cooling mode.

The first fluid entering through the fluid inlet port 14 does not flow into the closed first expansion valve 30 but directly enters the second expansion valve 60 for expansion. The first fluid expanded in the second expansion valve 60 flows into the first heat exchanger 20 for heat exchange with the second fluid.

While the foregoing description has focused on specific embodiments of the present invention, it should be understood that various modifications and changes can be made by those skilled in the art without departing from the spirit and scope of the invention as defined in the appended claims.

### DESCRIPTION OF REFERENCE NUMERALS

10: manifold plate 12: bottom plate
14: fluid inlet port 16: accumulator port
20: first heat exchanger 21: first inlet port
22: first outlet port 23: second inlet port
24: second output port 30: first expansion valve
40: gas-liquid separator 42: housing
44: deflector 46: fluid inlet passage
48: discharge tube 50: top cap
60: second expansion valve 70: first direction switching valve
80: second direction switching valve 90: second heat exchanger
100: third expansion valve

1. A manifold fluid module integrated with a gas-liquid separator, the manifold fluid module comprising:
a manifold plate comprising a fluid passage formed internally;
a first expansion valve coupled to the manifold plate and configured to block the flow of a first fluid or expand the first fluid based on air conditioning mode; and
a gas-liquid separator at least partially integrally formed with the manifold plate to create an inflow space for the first fluid expanded by the first expansion valve and to separate the first fluid into gas and liquid phases.

2. The manifold fluid module integrated with a gas-liquid separator according to claim 1, wherein the gas-liquid separator is positioned on the upper part of the manifold plate.

3. The manifold fluid module integrated with a gas-liquid separator according to claim 1, wherein the gas-liquid separator is positioned on the outside of the manifold plate.

4. The manifold fluid module integrated with a gas-liquid separator according to claim 1, wherein the gas-liquid separator comprises:
a housing having an internal space through which the first fluid flows;
a discharge tube positioned in the upper part of the housing to discharge the gas phase of the first fluid and prevent the inflow of the liquid phase of the first fluid; and
a top cap coupled to the top of the housing to be positioned between the housing and the discharge tube.

5. The manifold fluid module integrated with a gas-liquid separator according to claim 4, wherein the housing is formed integrally with the manifold plate, and the top cap is separately fabricated to be coupled to the top of the housing.

6. The manifold fluid module integrated with a gas-liquid separator according to claim 4, wherein the housing comprises a fluid inlet path formed on one side of the upper part of the housing for the first fluid expanded by the first expansion valve, and the fluid inlet path is configured to open tangentially for the first fluid to form a spiral vortex.

7. The manifold fluid module integrated with a gas-liquid separator according to claim 1, wherein the first expansion valve expands the first fluid to move the expanded fluid to the gas-liquid separator in vapor injection heat pump mode and remains closed in normal heat pump mode to allow the first fluid to flow toward the second expansion valve.

8. The manifold fluid module integrated with a gas-liquid separator according to claim 1, further comprising:
a second expansion valve coupled to the manifold plate for expanding the liquid phase of the first fluid separated in the gas-liquid separator; and
a third expansion valve coupled to the manifold plate for expanding the first fluid that has exchanged heat with an external heat exchanger.

9. The manifold fluid module integrated with a gas-liquid separator according to claim 8, further comprising:
a heat exchanger coupled to the manifold plate for heat exchange between the first fluid and a second fluid,
wherein the heat exchanger comprises:
a first heat exchanger for heat exchange between the first fluid expanded by the second expansion valve and the second fluid; and
a second heat exchanger for heat exchange between the first fluid expanded by the third expansion valve and the second fluid.

10. The manifold fluid module integrated with a gas-liquid separator according to claim 9, wherein the first heat exchanger is arranged on one side of the manifold plate, and the second heat exchanger is arranged laterally adjacent to the first heat exchanger.

11. The manifold fluid module integrated with a gas-liquid separator according to claim 9, wherein the first expansion valve and the second expansion valve are positioned above the first heat exchanger, and the third expansion valve is positioned above the second heat exchanger, allowing the first fluid flowing into the first and second heat exchangers to move from top to bottom.

12. The manifold fluid module integrated with a gas-liquid separator according to claim 11, further comprising a first direction switching valve and a second direction switching valve for controlling the direction of the first fluid discharged from the first heat exchanger,
wherein the first direction switching valve is positioned below the second heat exchanger, and the second direction switching valve is positioned between the first heat exchanger and the second heat exchanger.

13. The manifold fluid module integrated with a gas-liquid separator according to claim 12, wherein the gas-liquid separator, the first expansion valve, the second expansion valve, and the third expansion valve are arranged on the upper part of the manifold plate, the first heat exchanger is arranged on one side of the lower part of the manifold plate, and the second heat exchanger, the first direction switching valve, and the second direction switching valve are arranged on the other side of the lower part of the manifold plate.
